(19) United States
(12) Patent Application Publication
(10) Pub. No.: US 2014/0207705 A1
(43) Pub. Date: Jul. 24, 2014

(54) RESIDUAL RISK ANALYSIS SYSTEM, METHOD AND COMPUTER PROGRAM PRODUCT THEREFOR

(71) Applicant: ALG, Inc., Santa Barbara, CA (US)

(72) Inventors: Oliver Thomas Strauss, Santa Barbara, CA (US); Morgan Scott Hansen, Santa Barbara, CA (US)

(73) Assignee: ALG, Inc., Santa Barbara, CA (US)

(21) Appl. No.: 14/031,846

(22) Filed: Sep. 19, 2013

Related U.S. Application Data
(60) Provisional application No. 61/756,363, filed on Jan. 24, 2013.

(51) Int. Cl. G06Q 40/06

(52) U.S. Cl. CPC G06Q 40/06
USPC 705/36 R

(57) ABSTRACT

Systems, methods and products for determining residual values of asset portfolios are disclosed. In one embodiment, a system includes a server computer coupled to a network and to a data storage device. The server generates residual value curves for each of a set of item types and stores them. The server computer also receives and/or maintains information defining a set of items in a portfolio. When an assessment of the portfolio is initiated, the server determines a residual value for each item in the portfolio by identifying a corresponding one of the item types, retrieving the residual value curve corresponding to the identified item type, and determining a future value of the item based on the retrieved residual value curve for the corresponding item type. The server then aggregates the individual residual values into a residual value for the portfolio and enables access to this value.

### CROSS-REFERENCE TO RELATED APPLICATION(S)

This is a conversion of, and claims a benefit of priority from U.S. Provisional Application No. 61/756,363, filed Jan. 24, 2013, entitled, “RESIDUAL RISK ANALYSIS SYSTEM, METHOD AND COMPUTER PROGRAM PRODUCT THEREFOR,” which is fully incorporated herein by reference.

### TECHNICAL FIELD

This disclosure relates generally to forecasting future market value of durable goods, and more particularly to systems, methods and computer program products for determining future values of individual items in an asset portfolio based on residual value forecasts for corresponding asset types and aggregating the individual asset values into an overall portfolio forecast value.

### BACKGROUND OF THE RELATED ART

The market value of an item (e.g., a vehicle, a real estate property, etc.) is known at the time that it is sold to a consumer. After this initial transaction, however, the item's resale value is generally unknown. For a durable good or product, the resale value may be affected by various factors such as time, the availability of same or similar products, the geographical location where the product physically resides, demand in for the product in the resale market and/or industry, the purchasing power of the target buyers, and so on.

Although the value of an item is easily established at the time the item was first sold, the value of the item will change (e.g., devalue) over time. The farther away in time a forecast is relative to the baseline, the more uncertainty will exist. Thus, the forecasting error will grow as the width of the time interval increases. The initial value, as well as the factors affecting the value of the item over time, vary with different types of items. These difficulties are multiplied when attempting to accurately forecast the value of an entire portfolio of different items.

The difficulty of assessing the value of a portfolio of items may impact a company's business decisions. For example, consider a company that has a lease and loan portfolio. Each item in the portfolio represents a vehicle. One of the challenges faced by the company is to be able to assess the financial risk (losses and gains) on such a lease and loan portfolio (e.g., for purposes of obtaining financing based on the lease and loan portfolio. Because of these difficulties, it would be desirable to provide improved means for determining the residual value of a portfolio of assets.

### SUMMARY OF THE DISCLOSURE

This disclosure is directed to systems, methods and computer program products for forecasting future values of a portfolio of assets. One particular embodiment is directed to a system for forecasting a future value of a portfolio of items. The system includes a server computer that is coupled to a network and to a data storage device. The server computer is configured to generate a residual value curve for each of a set of item types. The residual value curves are then stored in the data storage device for use in calculating residual values of items. The server computer also receives and/or maintains information defining a set of items (assets) that are associated with a portfolio. A customer associated with the portfolio may then request or otherwise initiate an assessment of the residual value of the portfolio. When the assessment is initiated, the server computer first determines a residual value for each item in the portfolio, and then aggregates the individual residual values into a residual value for the portfolio. This includes, for each of the items in the portfolio, identifying a corresponding one of the item types, retrieving the residual value curve corresponding to the identified item type, and determining a future value of the item based on the retrieved residual value curve for the corresponding item type. When the future values have been determined for all of the items in the portfolio and these values have been aggregated for the portfolio, the server computer can enable a client device to access the aggregated future values.

The server computer may identify the item type corresponding to a particular item by identifying a type number (e.g., a vehicle identification number) associated with the item, and selecting the item type that is associated with the identified type number. If none of the types in the set defined for the system match the item, the system may instead select one of the types that is a near-match for the item, or it may use a composite of several types (e.g., types corresponding to competitive items) to approximate a match for the item. The set of item types defined for the system may be used to assess the future values of multiple, distinct portfolios of items. The system may be configured to enable a client device to provide inputs from the customer associated with the portfolio. These inputs can then be used to modify the residual value curves for the item types, or the computation of the residual values based on the residual value curves. The modifications based on customer inputs may be interactively adjusted through a work bench application executing on a client device. The system may alternatively utilize a type that is a partial match for the item.

An alternative embodiment comprises a method for forecasting future values of an item. In this method, residual value curves are generated for each of a set of item types and then stored. When it is desired to assess the residual value of a portfolio, each of the items in the portfolio is examined. For each of the items in the portfolio, a corresponding one of the item types is identified, and a residual value curve corresponding to the identified item type is retrieved. The future value of the item is then determined based on the retrieved residual value curve. As the residual value of each item is determined, the values are aggregated, and the aggregated future values are stored. A client device can then be enabled to access the aggregated future values (e.g., by accessing the data storage device in which the values are stored, or by transmitting the values to a client device). Another alternative embodiment may comprise a computer program product that comprises a non-transitory computer-readable storage medium which stores computer instructions that are executable by a processor to perform this method.

Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. A more complete understanding of the disclosure and the advantages thereof may be acquired by referring to the following description, taken in conjunction with the accompanying drawings in which like reference numbers indicate like features.

FIG. 1 depicts a diagram illustrating an exemplary network environment in which embodiments disclosed herein may be implemented.

FIG. 2 depicts a diagram illustrating an exemplary system architecture in which embodiments disclosed herein can be implemented.

FIG. 3 depicts a diagram illustrating an exemplary embodiment of a residual risk analysis modeling methodology.

FIG. 4 depicts a diagram illustrating an exemplary residual value curve provided by a system implementing an embodiment of a residual risk analysis modeling methodology disclosed herein.

FIG. 5 depicts a diagram illustrating an exemplary set of original and adjusted residual value curves in one embodiment.

FIG. 6 depicts a diagram illustrating an exemplary self-correcting mechanism for fine-tuning a residual value curve over time utilizing a bounding function.

FIG. 7 depicts a flow diagram illustrating an alternative method for forecasting the value of a portfolio of assets.

FIG. 8 depicts a more detailed flow diagram illustrating the method of FIG. 7.

FIG. 9 depicts a flow diagram illustrating the manner in which forecast information is used to determine the future values of specific items in a portfolio in one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DETAILED DESCRIPTION

One or more embodiments of the invention are described below. It should be noted that these and any other embodiments described below are exemplary and are intended to be illustrative of the invention rather than limiting. The disclosure and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard drive (HD)), hardware circuitry or the like, or any combination.

For the purposes of this disclosure, the term “item” may be used to refer to a durable good, product, or any item that has a known value at the time it was first sold and that has a different resale value over time thereafter. Examples of an item may include a vehicle, a real estate property, etc. The term “portfolio”, as used herein, refers to a set of items.

For a durable good or product (an “item”), the resale value of the item may be affected by various factors such as time, the availability of same or similar items, the geographical location where the item physically resides, demand in for the item in the resale market and/or industry, the purchasing power of the target buyers, and so on. An ability to determine the amount by which the item will change (e.g., devalue) over time, and thereby forecast the resale or residual value of the item can provide a better understanding of a company's assets and can allow the company to make better business decisions.

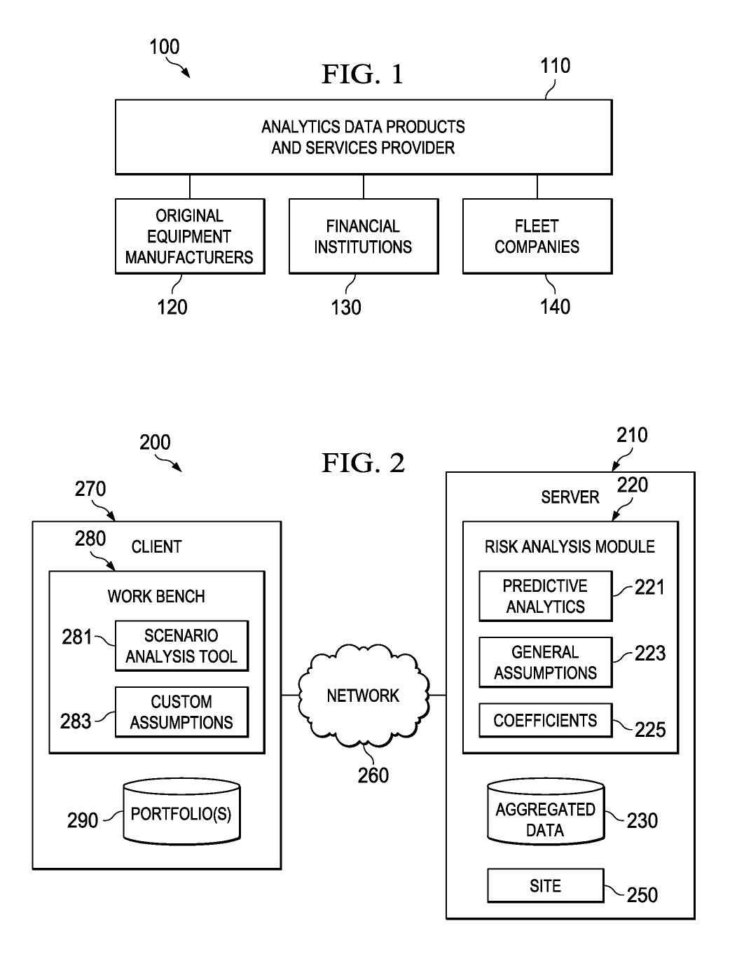

Turning now to FIG. 1, which depicts a diagrammatic representation of an example network environment in which embodiments disclosed herein can be implemented. In network environment 100, analytics data products and services provider 110 may be communicatively connected to a plurality of clients, including original equipment manufacturers (OEMs) 120, financial institutions 130, fleet companies 140, etc. An example of analytics data products and services provider 110 can be ALG, Inc. of Santa Barbara, Calif. Analytics data products and services provider 110 may aggregate and/or generate various types of data including, but are not limited to, residual value data, residual impact data, incentive data, brand data, as well as new vehicle pricing analysis data, depreciation curve analysis data, and loan severity analysis data, etc. Utilizing proprietary analytical data and software products, Analytics data products and services provider 110 may provide automotive residual values, analytical data products, and portfolio evaluation to OEMs 120, financial institutions 130, and fleet companies 140. An example portfolio evaluation may include residual risk, return rate, and lease and loan portfolio analysis. It will be appreciated that OEMs 120, financial institutions 130, and fleet companies 140 represent example clients that may be communicatively connected to analytics data products and services provider 110 and that there can be additional types of clients not illustrated in FIG. 1. Each such client may be communicatively connected to analytics data products and services provider 110 via a client-server architecture as exemplified in FIG. 2.

In this disclosure, a “client” may, for example, be a device operated by a customer of an analytics data products and services provider. Although in examples described herein, clients may be operated by business entities and enterprises alike, those skilled in the art will appreciate that a client may also be operated by an individual consumer. Whether being operated by a business entity or an individual, a client may include the necessary hardware and software to enable devices operated by the customer to communicate with the server operated by the analytics data products and services provider. Similarly, a “server” may include the necessary hardware and software that enable the analytics data products and services provider to communicate with the client devices of its customers.

FIG. 2 depicts a diagrammatic representation of exemplary system architecture 200 in which some embodiments disclosed herein can be implemented. Server 210 may represent one or more server machines residing in an enterprise computing environment that is owned and operated by an entity such as analytics data products and services provider 110 described above. Server 210 may host site 250 having a unique domain name. Site 250 may be accessible by client 270 over network 260. Network 260 may represent one or more wired and/or wireless communications networks, including a public network. The Internet is an example of a public network. Client 270 may be communicatively connected to server 210 over a secure connection in a manner known to those skilled in the art. Various servers, clients, data sources and other devices may also be coupled to client 270 and server 210 through network 260.

At server 210, a variety of data may be collected, generated, or otherwise aggregated and store the aggregated data in database 230. The aggregated data may be analyzed to determine certain general assumptions on factors or variables that may affect residual values of a certain item or items in some ways. For example, one or more companies may provide information on vehicles that they own, finance terms for leases involving these vehicles, and return rates indicating the actual lengths of these leases. Sales data on these vehicles may also be collected and correlated to the return rates. As an example, based on the aggregated data, it may be determined that, on average, the return rate for a 36-month lease of a vehicle having a particular Year-Make-Model-Body is 30-month. This general assumption, which may be part of general assumptions 223, can be stored and accessible by risk analysis module 220.

For purposes of clarity, a single client computer and a single server computer are shown in the figure. The client and server computers and data source represent an exemplary hardware configuration of data processing systems that are capable of bi-directionally communicating with each other over a public network such as the Internet. Those skilled in the art will appreciate that server 210 may comprise multiple server computers, and multiple client computers may be bi-directionally coupled to the server over network 260.

Client computer 270 can include, for example, a central processing unit (“CPU”), a read-only memory (“ROM”), a random access memory (“RAM”), a hard drive (“HD”) or storage memory, and input/output device(s) (“I/O”). I/O devices can include keyboards, monitors, printers, and/or electronic pointing device, among others. Client computer 270 can include a desktop computer, a laptop computer, a personal digital assistant, a cellular phone, or nearly any device capable of communicating over a network. Server computer 210 may have similar hardware components, including a CPU, a ROM, a RAM, a HD, and I/O devices.

Each computer shown in FIG. 2 is an example of a data processing system. The ROM, RAM, HD, databases and other types of data storage can include media that can be read by a CPU and may therefore be construed as computer-readable storage media. These media may be internal or external to the client and server computers.

Portions of the methods described herein may be implemented in suitable software code that may reside within the ROM, RAM, HD, database, or other storage devices or combinations thereof. In some embodiments, computer instructions implementing an embodiment disclosed herein may be stored on a DASD array, magnetic tape, floppy diskette, optical storage device, or other appropriate computer-readable storage medium or storage device. A computer program product implementing an embodiment disclosed herein may therefore comprise one or more computer-readable storage media storing computer instructions translatable by the CPU to perform an embodiment of a method disclosed herein.

In an illustrative embodiment, the computer instructions may be lines of compiled C++, Java, or other language code. Other architectures may be used. For example, the functions of server computer 210 may be distributed and performed by multiple computers in an enterprise computing environment. Accordingly, each of the computer-readable storage media storing computer instructions implementing an embodiment disclosed herein may reside on or accessible by one or more computers in the enterprise computing environment.

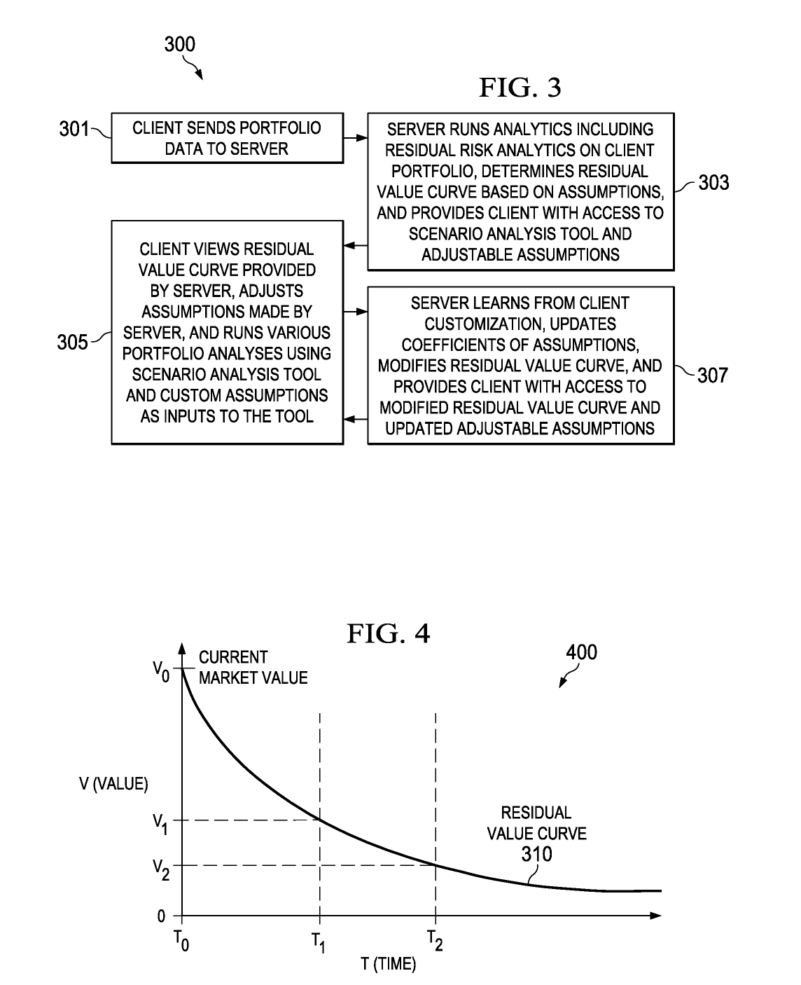

FIG. 3 depicts a flow diagram illustrating an exemplary embodiment of a residual risk analysis modeling methodology. FIG. 3 shows that client 270 may, at step 301, provide data associated with one or more portfolios 290 to server 210. In turn, at step 303, server 210 may run predictive analytics 221 on portfolio 290, determine a residual value curve representing forecasted residual values of portfolio 290 (or individual items within the portfolio) over time, based on general assumptions 223 and configurable coefficients 225, and provide work bench 280 to client 270. In one embodiment, work bench 280 may be provided to client 270 via site 250. For example, site 250 may be implemented as a website comprising a plurality of web pages, one of which may be generated based on interface logic provided by server 210 to present work bench 280 to client 270. Work bench 280 may allow client 270 access to scenario analysis tool 281 and adjustable assumptions 283 provided by server 210.

Scenario analysis tool 281 may be part of a plurality of online modeling tools provided by server 210 to client 270. The plurality of online modeling tools may include, for example, a tool may provide for on-demand vehicle residual value and pricing analysis. Another tool may allow for calculation of vehicle residual values and corresponding monthly lease payments. Yet another tool may be utilized to determine the amount of depreciation of a vehicle over the lifetime of ownership. A further tool may allow analysis of risk through detailed study of return rates and historic market trends. To this end, server 210 may include risk analysis module 220 implementing a proprietary residual risk analysis (RRA model) and configured to provide predictive analytics 221 based general assumptions 223 and coefficients 225 of the RRA model.

The RRA model is used to build a residual value curve for various items of interest. The residual value model provides a methodology for forecasting residual values of an item in two successive time periods and determining changes in a valuation metric. By estimating the changes in value for successive future time intervals, a function can be constructed to capture the estimated relationship between time and the item's value. The current market value of an item at the beginning of an estimation period is known and can be used as a baseline against which future values are computed. The farther away in time a forecast is relative to the baseline, the more uncertainty will exist. Thus, the forecasting error will grow as the width of the time interval increases.

It should be noted that the term “residual value curve” is conveniently depicted as a graphical representation of the future value of an item or set of items, this representation is intended to be illustrative, rather than limiting. “Residual value curve” should be construed to include any type of forecast of the future value of an item or set of items. These forecasts may include graphical representations, mathematical representations, data sets, or any other suitable representations of forecast values.

FIG. 4 depicts plot diagram 400 showing example residual value curve 410 where the market value of an item i in the current, initial time point, t₀, is V_{i,0} but continually declines over time. For example, the forecasted value of V₁ at T₁ is less than V₀ and the forecasted value of V₂ at T₂ is lower than V₁. In the residual value model, although modifications can be made to the baseline value to produce forecasted values, the baseline value of an item is fixed over time. More specifically, an item is evaluated for its residual values as it moves through time, with an assumption that the item itself hasn't changed. For example, a car may have 15,000 miles on Jan. 1, 2013. When forecasting the residual value of the car on Mar. 1, 2013, an assumption is made that the car still has just 15,000 miles on it. This may not be true when the car is in use, off the lot from a dealership. As the car is being driven, its mileages increase and the car can actually move down in value. This type of depreciation is not time-dependent. Furthermore, the system providing the residual value model and the associated analytics may have little or no actual knowledge of the condition of the particular car as it is being driven.

Taking this uncertainty into consideration, the residual value model utilizes different types of variables to aid in forecasting residual values of an item over time. Example types of forecasting variables include, but are not limited to:

Modifications (Mi) that reflect any changes to an item i that may affect its value at any time point—examples include options added to the item in prior periods, different configurations/styles of the item, and other features which may distinguish one item from another yet produced by the same manufacturer.

Macroeconomic factors (F) that are related to the overall economy, not the specific industry to which the item i is associated (e.g., the real estate or automotive industries)—examples include inflation, unemployment, and interest rates.

Microeconomic factors (Gₚ) that pertain the specific industry p to which the item i is associated—examples would be the supply and demand, industry trends, seasonality and volatility of the item.

Depreciation (Dᵢ) that represents the natural change in value that occurs as the item i is used over time.

Competitive sets (C_{iU}) that include all other items, j=1, . . . , J (i≠j), in the same industry p and in the competitive set U (which are reasonable substitutes for the item i being valued)—examples include items produced by different manufacturers that share similarities with the item i being valued and also sales incentives applied to the item i being valued or its substitutes. For a full explanation of an example competitive set approach, readers are directed to U.S. patent application Ser. No. 13/173,332, filed Jun. 30, 2011, entitled “SYSTEM, METHOD AND COMPUTER PROGRAM PRODUCT FOR PREDICTING ITEM PREFERENCE USING REVENUE-WEIGHTED COLLABORATIVE FILTER,” which is fully incorporated herein by reference. Other competitive set approaches may also be possible.

Locality (Lₚ) that represents a valuation differences in industry p (that vary geographically)—examples would include adjustments made to allow valuation to be conducted at both the national and state/province.

More detailed explanations and examples of forecast methodologies are provided in U.S. patent application Ser. No. 13/967,148, filed Aug. 14, 2013, entitled “SYSTEM, METHOD AND COMPUTER PROGRAM FOR FORECASTING RESIDUAL VALUES OF A DURABLE GOOD OVER TIME,” which is incorporated herein by reference.

In one embodiment, the residual values of an item i (V_{i,n}) may be expressed in an equation below as a function of time tₙ (n=0, . . . , T):

V_{i,n}=(V′_{i,0}+M_{i,n})×(τ_{i,n}×L_{p,n})×D_{j,n|0}+(F.,_{n|n-h}+G_{k,n|n-h})+C_{iU,n|n}*, where h=1, . . . ,H

In the above equation, “F.” implies that the macroeconomic factors are taken over all p=1, . . . , P and “n*” pertains to period tₙ* defined as “a reference period, tₙ* at which adjustments will be made to align values with other items in the competitive set”. Further,

V′_{i,0} represents the market value at time t₀ before modifications, reflecting the level of the base configuration of item i at period t₀, prior to modifications and locality adjustments,
V_{i,n} reflects the level of the variable for the item i at period tₙ,
τ_{i,n}={1 if tₙ=0; 0 otherwise}
L_{p,n} reflect the locality adjustment made at time tₙ to all items in for industry p (iεp),
F.,_{n|n-h} reflects the level of a macroeconomic (neither industry- nor item-specific) variable at period tₙ, given the historical information about that the variable in the last =1, . . . , H periods (tₙ₋₁, tₙ₋₂, . . . , t_{n-H}),
G_{p,n|n-h} reflect the level of the microeconomic variable at period tₙ given the historical information for industry p (iεp) available about that variable in the last =1, . . . , H periods (tₙ₋₁, tₙ₋₂, . . . , t_{n-H}),
D_{j,n|0} reflects the observed natural depreciation for another item j in the same competitive set as item i at time period t₀, and
C_{iU,n|n}* reflects an competitive set adjustment made to item i based at time period tₙ* based on an observed discrepancy between V_{i,n} and the predicted values of all other items, j=1, . . . , J (i≠j) in the competitive set U (i,jεU∀j) evaluated at some reference period, tₙ.

As noted above, the baseline residual value curve may not take into account such factors as the actual condition of a particular item. Accordingly, the present systems, methods and computer program products may implement a residual risk analysis (RRA) that determines the residual value and risks of an item in use, taking into consideration one or more factors affecting the baseline value of the item. This can be important for evaluating a portfolio (group) of assets, e.g., a fleet of leased cars, in providing an analysis of financial risk on a client's portfolio as a whole. A system implementing the RRA model may track a portfolio throughout time and assess its value as the assets in the portfolio are being used. The present systems, methods and computer program products may also provide customization and scenario analysis tools in a user-friendly manner, enabling each customer communicatively connected to the system to adjust assumptions based on its own internal data. The system can learn from assumptions as adjusted and/or made by the customers, perhaps including the customers' own assumptions, and generate modified residual value curves with more accurate assumptions. The present systems, methods and computer program products may also provide a way to continuously monitor and update the residual value curve in a self-correcting manner to ensure that it accurately forecasts the residual values of the item throughout its lifetime. These forecasted residual values can be matched to items in a specific customer's portfolio and used to determine the overall value of the portfolio at any given time.

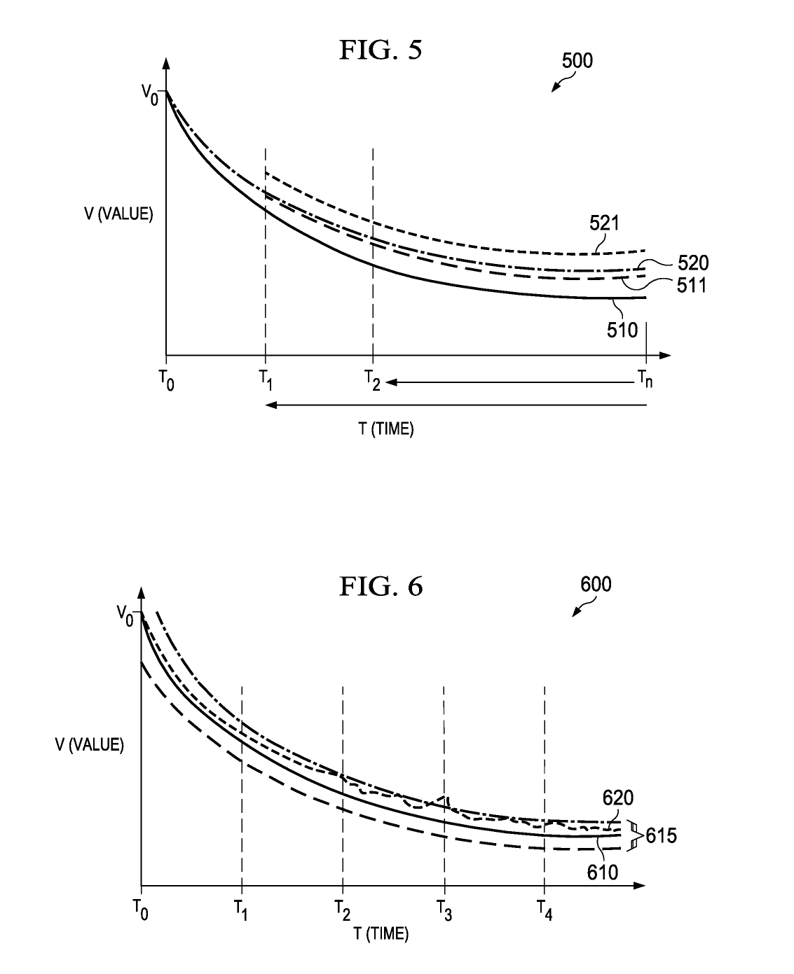

To this end, referring back to FIG. 3 and also FIG. 5, which depicts plot diagram 500 showing by example original residual value curve 510, modified residual value curve 511, first custom residual value curve 520, and second custom residual value curve 521 associated with an item i. Referring to FIG. 2, the item i may be part of portfolio 290 of client 270. As described above, risk analysis module 220 of server 210 may run predictive analytics 221 on portfolio 290 based on general assumptions 223 and coefficients 225 and provide original residual value curve 510 to client 270. Those skilled in the art will appreciate that each of coefficients 225 can be a multiplicative factor, serving as a weighting factor to an associated assumption or variable. Coefficients 225 do not need to be fixed and can be configurable to adapt to today's changing world. For example, a coefficient may be configured such that an “x” percentage change in economy can affect a particular assumption by “y” percentage.

Accordingly, original residual value curve 510 may represent forecasted values of the item i over time as affected by gas price, economy, outlooks, return rates, etc. As an example, suppose the item i represents a vehicle and a lease term for the vehicle is assumed to be 36 months. Original residual value curve 510 may indicate to client 270 that, at 24-months out in use, how much residual value the vehicle may have when it comes back in twelve months, at the end of the assumed lease term. Client 270 may have better information on the return rates from vehicles similar to the one being represented by original residual value curve 510. For example, instead of 36-month, client 270 may have data evidencing that on average the return rate is 30-month. Work bench 280 running on a client device associated with client 270 allows client 270 to modify the general assumption on the return rate from 36-month to 30-month. Client 270 may adjust one or more or all of general assumptions 223 based on which original residual value curve 510 was determined at the server side. Work bench 280 may provide an input feature such as a slider, a drop down menu, a field, or the like to allow client 270 to adjust the return rate to 32 months.

Furthermore, using scenario analysis tool 281 provided through work bench 280, client 270 can configure different scenarios, each testing an impact on a forecasted value. Suppose an internal analysis indicate that the gas price is going to spike in three months from now, client 270 may test the impact of such a gas price hike on a forecasted value of a loan portfolio of a fleet of vehicles three months from now by adjusting an assumption corresponding to the gas price. Since this adjusted assumption is communicated to the back end, server 210 can mine the client-provided input data to make better assumptions. Via scenario analysis tool 281, client 270 can also adjust other parameters such as time and value.

Referring to FIG. 3, at step 305, client 270 may run various portfolio analyses using scenario analysis tool 281, with custom assumptions 283 as inputs. This customization allows client 270 to disagree with the general assumptions made by server 210 and produces first custom residual value curve 520, as shown in FIG. 5. Suppose client 270 is considering giving a loan to buy a fleet of vehicles, first custom residual value curve 520 can help client 270 to more accurately determine how many vehicles to buy, what residual values they may have at a certain time, how much to reserve for the financing, etc., based on custom assumptions that are particular to client 270. Such client-adjusted and/or client-provided custom assumptions 283 may be communicated to the back end and stored, for instance, in database 230. At step 307, server 210 may aggregate client customization data, such as client-adjusted and/or client-provided custom assumptions 283, from each client connected thereto.

Server 210 may analyze the client customization data collected from multiple clients and determine whether a trend exists, indicating a need to update a general assumption. For example, suppose in addition to client 270, multiple clients also adjusted their return rates to 30-month or a range there-within. This may indicate that a need to update the general assumption of 36-month. Referring to FIG. 5, a server-initiated fine-tuning process may begin sometime after the initial time point T₀, since there is no data at T₀. Thus, in the example of FIG. 5, modified residual value curve 511 begins at T₁, sometime after T₀. Because each client may have their own unique assumptions, custom assumptions from various clients may cause forecasted values of the same item at a certain time to go up, down, or remain the same. To this end, instead of trying to accommodate custom assumptions from various clients, risk analysis module 220 may learn from all the client inputs, determine a trend for each assumption, and compute modified residual value curve 511 based on the trends across multiple clients. Thus, modified residual value curve 511 may not be specific to any particular client.

As illustrated in FIG. 3, client 270 has access, e.g., via work bench 280, to the updated general assumptions and can yet again correct or otherwise adjust the updated general assumptions and run customized scenario analyses, producing second custom residual value curve 521, as depicted in FIG. 5. Another set of client customization data may therefore be provided to server 210 at T2 and server 210 may update the general assumptions and generate another corrected residual value curve as described above. This iterative process of fine-tuning the residual value curve may continue throughout the life of the item i, allowing server 210 to make more accurate assumptions which, in turn, makes more accurately forecasted residual values. In one embodiment, each residual value curve can be re-forecasted at a predetermined time interval, for instance, every two months. In one embodiment, the re-forecasting may be continuously performed for the life of a portfolio.

For the purpose of illustration, FIG. 5 shows smooth residual value curves. However, real world data can be volatile and it may not be possible to always produce smooth residual value curves. To address data volatility, some embodiments may include a self-correcting mechanism for fine-tuning a residual value curve over time utilizing a bounding function.

FIG. 6 depicts a plot diagram showing by example one embodiment of self-correcting mechanism 600 for fine-tuning residual value curve 610 over time utilizing bounding function 615. Suppose actual data 620 may cause server 210 to do updates at each predetermined time T₁, T₂, T₃, T₄, etc. There's no data at T₀. At T₁, it can be seen that actual data 620 corresponding to previously made general assumptions 223 had become available. Bounding function 615 operates to define a tolerable range (upper bound, lower bound) based on residual value curve 610. At each predetermined time, self-correcting mechanism 600 may operate to determine whether actual data 620 is out of bound. If so, residual value curve 610 may be recalculated using actual data 620. In some embodiments, the recalculation may also utilize general assumptions and/or updated assumptions, if available. If actual data 620 falls within bounds, residual value curve 610 may be considered as having acceptable accuracy in forecasting residual values and no recalculation may be necessary. This self-correcting, fine tuning process may be continuously performed throughout the life of the portfolio.

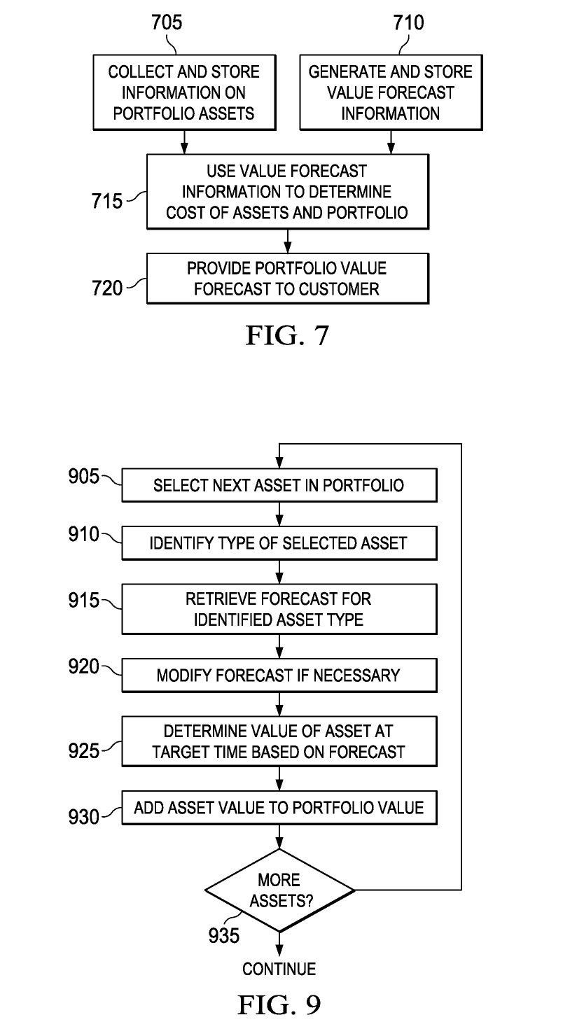

Referring to FIG. 7, a flow diagram illustrating a method for forecasting the value of a portfolio of assets in accordance with an alternative embodiment is shown. In this embodiment, a computer system such as that described above collects information regarding a set of assets that a customer has grouped together in a single portfolio (705). The computer system also produces forecasts information for various types of assets, including asset types that are representative of the assets in the customer's portfolio (710). As depicted in the figure, the collection of the customer's asset information (705) and the generation of forecast information (710) are performed in parallel. These activities may be performed asynchronously, since neither of the activities is dependent upon the other for completion. Thus, the collection of the asset information may occur before, during or after the generation of the forecast information.

After the asset information has been collected and the forecast information has been generated, the forecast information is used to determine forecasts values of each of the assets included in the customer's portfolio (715). The computer system examines the identifying information for each of the assets in the portfolio, and uses this information to determine which one of a set of residual value curves should be used to determine the forecast value of each asset. The forecast values of the individual assets are determined, and these values are aggregated to provide a value of the entire portfolio. The valuation information is then provided to the customer (720). The valuation information may include individual asset values, as well as the overall portfolio value.

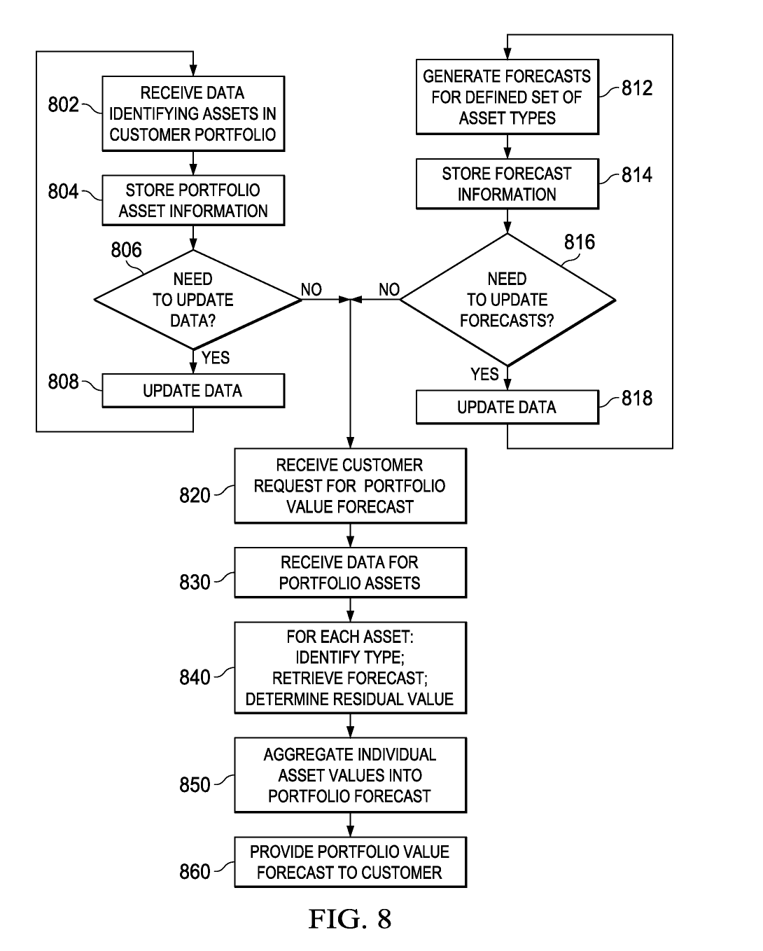

Referring to FIG. 8, a flow diagram illustrating the method of FIG. 7 in more detail is shown. As depicted in this figure, the method includes activities relating to the collection of customer asset information (802-808), as well as activities relating to the generation of forecast information for various item types (812-818). In regard to the collection of customer asset information, the information is collected by a server computer system (802) and is stored on a data storage device that is coupled to the server computer (804). The asset information may include various different types of information that enable the identification of the assets and assessment of their respective values. For example, if the portfolio of assets includes leased vehicles, the asset information may include vehicle identification numbers (VINs) of the vehicles, physical descriptions of the vehicles, information on the condition (e.g., mileage) of the vehicles, original values of the vehicles, and so on. The specific items of information stored for the assets may vary from one embodiment to another, and may include any appropriate information. The information may include both customer-provided information and information generated by the system itself. It may be desirable to periodically examine and/or update the asset information. For instance, if the assets include leased vehicles, the customer may wish to add or remove vehicles from the portfolio, update mileage or condition information, and so on. If it is determined that the asset information should be examined and/or updated (806), the method proceeds to an update activity (808).

The method of FIG. 8 also includes forecasts generation activities (812-818). As noted above in regard to FIG. 7, activities relating to the generation of forecast information (812-818) may be performed in parallel with activities relating to the collection of customer asset information (802-808). The forecast-related activities begin with the generation of forecast values for a defined set of asset types (812). The set of asset types in any particular embodiment will be determined by the assets for which a customer wishes to have forecast information. For instance, if the customer is a car leasing company, and the assets that are in the portfolio of interest comprise vehicles leased by the company, the set of asset types will include various different types of vehicles that may be leased by the customer. Preferably, each individual type of vehicle that may be leased will be included in the set of asset types. For instance, an asset type may be defined by a vehicle's make, model, year, trim-level and color. It may, however, be desirable or necessary to reduce the number of different asset types for which forecast information is generated, so some embodiments may group vehicles together. For example, the asset type may define the make, model and year of the vehicle, without regard to the tram-level or color. The “granularity” of the asset types may vary from one environment to another.

The system generates a separate forecast for each of the asset types in the defined set. Thus, if there are a number, N, of asset types in the set, the system will generate N forecasts—one for each of the asset types. These forecasts are then stored by the system in a local database or other suitable storage means (814) so that they can be retrieved and used in the determination of the future value of specific assets. The system may be configured to periodically determine (816) whether it is necessary to update the value forecasts for the asset types included in the set. For instance, it may be desirable to update the forecasts on a monthly basis in order to account for changing economic conditions, more recent historical sale information, etc. Updates may also be manually initiated. If it is time to update the forecast information, the method proceeds to the update activity (818), which may include, for example, updating information upon which the asset-type forecasts are based. The individual forecasts for the asset types may then be re-generated (812).

The manner in which the individual asset forecast values are determined is explained briefly above. It should be noted that the forecast information that is generated by the system can be used to determine the values of different portfolios of assets that may be owned by different entities. For example, forecast information may be generated for a set of commonly rented vehicle types. This same forecast information can then be used as the basis for determining the residual values of multiple vehicle portfolios owned by multiple car rental companies.

At step 820, a customer requests a valuation of a portfolio of assets. In one embodiment, the request specifies a portfolio of interest, as well as a target date for which the future value of the portfolio will be determined. The system may have information on a single portfolio of the customer's assets, or multiple portfolios. The system may also be configured to maintain asset information for one, or multiple customers. Valuations of the various portfolios of assets may be requested individually, or as a group. It should also be noted that the portfolio may include assets that are communicated to the system at the time the request for valuation is made, rather than, or in addition to, assets that were previously maintained by the system. When the portfolio of interest has been identified, the system retrieves the data corresponding to the particular assets contained in the portfolio (830). The system then goes through the list of assets in the portfolio and, based upon the forecast information that was previously generated (812-818), determines a separate value for each of the individual assets (840). In this embodiment, the value for each asset will be determined for the target date specified by the customer.

After the individual values for each of the assets in the portfolio has been determined, the system aggregates the individual values into an overall portfolio value (850). The determined overall portfolio value is then provided to the customer (860). In some embodiments, the system may be configured to provide the individual asset values, as well as the overall portfolio value, to the customer. The system may further be configured to provide any desired level of detail regarding the value analyses to the customer. In one embodiment, the valuation and related information is stored by the system on a local data storage device, and the customer is allowed by the system to access the stored data. In alternative embodiments, the valuation information and any other related information may be transmitted to an external client device that is operated by the customer. Various other means of delivering this information may also be employed.

The system may, in one embodiment, be designed to enable the customer to adjust various parameters affecting the forecasts for the various item types. The information specific to individual items in the portfolio can be modified by the customer as well. In one embodiment, the customer may utilize a work bench application installed on a client device to modify factors relating to the forecasts for all of the different item types, and then view the impact of these modifications on the forecast values for the portfolio and/or individual items in the portfolio. For instance, if the customer believes the price of gasoline will increase to a greater degree than is accounted for by the system, the customer can modify corresponding factors through the work bench application and examine the resulting changes in the forecast values.

As noted above, a detailed explanation of exemplary methods for generating the forecast information (e.g., residual value curves) is provided in the above-referenced U.S. patent application Ser. No. 13/967,148, filed Aug. 14, 2013, entitled “SYSTEM, METHOD AND COMPUTER PROGRAM FOR FORECASTING RESIDUAL VALUES OF A DURABLE GOOD OVER TIME.” Referring to FIG. 9, a flow diagram is provided to illustrate in more detail the manner in which this forecast information is used to determine the future values of specific items in a given portfolio.

The customer's request for a future valuation (820 of FIG. 8) identifies a particular portfolio. This portfolio includes a specific set of items. The items may be identifiable by any suitable means, typically including some unique information that is associated with each item, such as a serial number or a customer-assigned identification number. The portfolio may be defined by information that was stored by the system prior to the customer's request, or it may be provided by the customer with the request. In either case, the portfolio information is available to the system for assessment of its residual (future) value.

At step 905, the system examines the portfolio information and selects a first one of the items (assets) in the portfolio for processing. The system then identifies the type of the item (910). The specific set of items that are contained in the portfolio may be categorized into one or more different item types. For instance, if the customer is an automobile leasing company, the portfolio may include various different types of automobiles. As explained above, the “type” of each automobile may be defined with any desired level of granularity. In one embodiment, the type of an automobile is defined by the make, model, and trim level of the automobile. This information may be encoded in the VIN of the automobile, so the system may identify the vehicle type through the VIN.

The item types that are defined by the system do not necessarily have a one-to-one relationship with the items contained in the portfolio. There may be multiple items of a first type, one item of a second type, and no items of a third type. It may also be the case that the identifying information for the item be considered does not exactly match any of the item types for which the system has generated forecast information. In this case, it may be necessary to determine a suitable (e.g., “closest”) non-identical match for the item. For instance, if an automobile is identified as a Nissan Altima SV, but no corresponding type is maintained by the system, the automobile may be assigned to a comparable type, such as a Nissan Altima SL (another trim within the Altima model). Alternatively, the system may use a composite of multiple types corresponding to comparable automobiles for the automobile being considered.

When an appropriate type has been identified for the item being considered, the system retrieves the forecast information corresponding to the selected type (915). For example, if the item is a 2010 Nissan Altima, a residual value curve for 2010 Nissan Altima may be retrieved. The residual value curve shows the value of a 2010 Nissan Altima over a range of times extending into the future. The forecast value defined by the residual value curve may be modified, if necessary, to account for factors that may affect the value of the item being considered (920). For instance, the forecast value may be modified to account for the locality or condition of the item.

Based on the residual value curve, the value of the item at the target date specified by the customer is determined (925). In the case of a residual value curve, this simply entails determining the value of the curve corresponding to the target date. The value of the item can then be added to the overall value of the portfolio (930), or otherwise aggregated with the values of the other items. The aggregated value information for the portfolio may identify the overall portfolio value, a list of the individual values for the separate items in the portfolio, or any other suitable representation of the residual value information.

After the residual value of one of the items in the portfolio has been ascertained, the system determines whether there are additional items in the portfolio that need to be considered. If so, the system selects the next item in the portfolio (905) and proceeds to determine the value of the next item in the same manner described above. As the residual value of each item is determined, it is aggregated with the values of the other items. When the residual values of all of the items in the portfolio have been determined, the aggregated information is made available to the customer (see step 860 of FIG. 8).

Embodiments of the invention may provide a complex and sophisticated residual risk analysis model, system, and product to enable customers to properly assess financial risks in their portfolios in today's complex and sophisticated financial markets. More specifically, embodiments include analytical tools that allow for customization and scenario analyses on a portfolio at the client side. Customer-manipulated data can then be communicated back to the server and used at the server side to fine-tune the residual values of items in the portfolio. This fine-tuning process can be iterative, involving both the client side and the server side.

In some embodiments disclosed herein, a customer-facing work bench can be provided from a server to a client communicatively connected thereto over a network connection. In one embodiment, the work bench may be implemented as a web-based interface, providing the customer with access to a residual value curve determined at the back end based on a set of assumptions. Example assumptions may include, but are not limited to, macro-economic drivers, industry drivers such as incentive-spending, return rates, finance metrics, etc. These assumptions may be applicable to one or multiple customers. The work bench may allow the customer to perform customization of such assumptions and scenario analysis based on various custom assumptions. For example, for a customer owning a lease and loan portfolio, the work bench may include ‘war-game’ functionality and substituting modeling assumptions by customers. Using the work bench, the customer may perform modeling assumption analysis and loss severity analysis for loan(s) associated with the portfolio. The customer can run various portfolio analyses under differing macro-economic assumptions.

As a specific example, the customer may want to see the impact on the portfolio while deviating from the provided assumptions such as lease return rates based on which the original residual value curve was determined. In this case, the customer can upload their own assumptions on the lease return rates, which may be determined based on their internal data, to customize their residual risk analysis. Based on the customer-provided assumptions, a custom residual value curve may be created and presented to the customer. In some embodiments, a modified residual value curve may also be created and presented to the customer. The modified residual value curve may be determined based on assumptions as adjusted by a plurality of customers, actual data, or a combination thereof.

Using the work bench, the customer may further adjust the custom residual value curve by adjusting a particular forecasted residual value with respect to a particular point in time, adjusting a particular point in time with respect to a particular forecasted residual value, or both. In an iterative process, another modified residual value curve may be determined based on assumptions as adjusted by a plurality of customers, actual data, or a combination thereof. A system implementing such an iterative process may be configured to perform a residual risk analysis at a predetermined time interval to ensure that the residual value curve is as accurate as it can be, given the data that had been aggregated both at the client side and at the server side. Optionally, a bounding function may be utilized to determine whether to recalculate the residual value curve or whether the current residual value curve is within an acceptable range. In some embodiments, the functionality of the residual risk analysis modeling method disclosed herein may implement advanced regression techniques such as scenario analysis functionality.

Embodiments disclosed herein may provide many advantages. For example, embodiments can help financial lenders in the automotive market to minimize exposure risk in their financial lease and loan portfolios. As described herein, the scenario analysis functionality is taken to a further level to adapt to the more complex and sophisticated financial market place with more demand for customization and scenario analysis.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A system for forecasting a future value of a portfolio of items, the system comprising:
a server computer coupled to a network; and
a data storage device coupled to the server computer;
wherein for each of a plurality of item types in a set of item types, the server computer is configured to generate a residual value curve and to store the residual value curve on the data storage device;
wherein for each of a plurality of items in a set of items, the server computer is configured to:
identify a corresponding one of the item types;
retrieve the residual value curve corresponding to the identified item type; and
determine a future value of the item based on the retrieved residual value curve for the corresponding item type;
wherein the server computer is configured to aggregate the future values of the items in the set of items and to store the aggregated future values in the data storage device; and
wherein the server computer is configured to enable a client device to access the aggregated future values.

2. The system of claim 1, wherein the server computer is configured to modify the residual value curve for at least one of the item types based on input received from a client device and to determine the future values of ones of the items associated with the modified residual value curves.

3. The system of claim 1, wherein for each item in the set of items, the server computer is configured to identify the corresponding item type by identifying a type number associated with the item, and identifying one of the item types that is associated with the type number.

4. The system of claim 1, wherein for each item in the set of items, the server computer is configured to identify the corresponding item type by identifying a first type number associated with the item, and identifying one of the item types that is associated with a second type number that is a partial, non-identical match of the first type number.

5. The system of claim 1, wherein the items comprise vehicles, wherein for each vehicle in the set of vehicles, the server computer is configured to identify a vehicle identification number (VIN) associated with the vehicle, and identify one of the item types that is associated with the VIN.

6. The system of claim 1, wherein the server computer is configured to generate residual value curves for a common set of item types, and wherein the server computer is further configured to determine future values of items contained in multiple, distinct sets of items based on the residual value curves of the common set of item types.

7. The system of claim 1, wherein the server computer is configured to determine, for one or more of the items, corresponding future values that are based at least in part on item-specific information that is associated with corresponding ones of the items in addition to the residual value curves for the item types associated with the items.

8. A method for forecasting future values of an item, the method comprising:
for each of a plurality of item types in a set of item types, a server computer generating a residual value curve and storing the residual value curve on a data storage device;
for each of a plurality of items in a set of items, the server computer performing:
identifying a corresponding one of the item types;
retrieving the residual value curve corresponding to the identified item type;
determining a future value of the item based on the retrieved residual value curve for the corresponding item type;
aggregating the future values of the items in the set of items;
storing the aggregated future values in the data storage device; and
enabling a client device communicatively connected to the server computer to access the aggregated future values.

9. The method of claim 8, further comprising performing, by the server computer:
receiving input from a client device;
modifying the residual value curve for at least one of the item types based on the input received from the client device; and
determining the future values of ones of the items associated with the modified residual value curves.

10. The method of claim 8, wherein for each item in the set of items, identifying the corresponding item type comprises identifying a type number associated with the item, and identifying one of the item types that is associated with the type number.

11. The method of claim 8, wherein for each item in the set of items, identifying the corresponding item type comprises identifying a first type number associated with the item, and identifying one of the item types that is associated with a second type number that is a partial, non-identical match of the first type number.

12. The method of claim 8, wherein for each item in the set of items, identifying the corresponding item type comprises identifying a vehicle identification number (VIN) associated with the vehicle, and identifying one of the item types that is associated with the VIN.

13. The method of claim 8, further comprising performing, by the server computer:
generating residual value curves for a common set of item types; and
determining future values of items contained in multiple, distinct sets of items based on the residual value curves of the common set of item types.

14. The method of claim 8, further comprising performing, by the server computer for one or more of the items:
determining corresponding future values based at least in part on item-specific information that is associated with corresponding ones of the items in addition to the residual value curves for the item types associated with the items.

15. A computer program product comprising at least one non-transitory computer-readable storage medium storing computer instructions that are translatable by a server computer to perform:
for each of a plurality of item types in a set of item types, generating a residual value curve and storing the residual value curve on a data storage device;
for each of a plurality of items in a set of items:
identifying a corresponding one of the item types;
retrieving the residual value curve corresponding to the identified item type;
determining a future value of the item based on the retrieved residual value curve for the corresponding item type;
aggregating the future values of the items in the set of items;
storing the aggregated future values in the data storage device; and
enabling a client device communicatively connected to the server computer to access the aggregated future values.

16. The computer program product of claim 15, wherein the computer instructions are further translatable by the server computer to perform:
receiving input from a client device;
modifying the residual value curve for at least one of the item types based on the input received from the client device; and
determining the future values of ones of the items associated with the modified residual value curves.

17. The computer program product of claim 15, wherein for each item in the set of items, identifying the corresponding item type comprises:
identifying a type number associated with the item; and
identifying one of the item types that is associated with the type number.

18. The computer program product of claim 15, wherein for each item in the set of items, identifying the corresponding item type comprises:
identifying a first type number associated with the item; and
identifying one of the item types that is associated with a second type number that is a partial, non-identical match of the first type number.

19. The computer program product of claim 15, wherein for each item in the set of items, identifying the corresponding item type comprises:
identifying a vehicle identification number (VIN) associated with the vehicle; and
identifying one of the item types that is associated with the VIN.

20. The computer program product of claim 15, wherein the computer instructions are further translatable by the server computer to perform:
generating residual value curves for a common set of item types; and
determining future values of items contained in multiple, distinct sets of items based on the residual value curves of the common set of item types.

21. The computer program product of claim 15, wherein the computer instructions are further translatable by the server computer to perform:
for one or more of the items, determining corresponding future values based at least in part on item-specific information that is associated with corresponding ones of the items in addition to the residual value curves for the item types associated with the items.
